(19) United States
(12) Patent Application Publication
(10) Pub. No.: US 2026/0005335 A1
(43) Pub. Date: Jan. 1, 2026

(54) BATTERY PACK

(71) Applicant: ZHEJIANG JINKO ENERGY STORAGE CO., LTD., Jiaxing (CN)

(72) Inventor: Yuanhang CHEN, Haining (CN)

(21) Appl. No.: 18/904,323

(22) Filed: Oct. 2, 2024

(30) Foreign Application Priority Data
Jun. 27, 2024 (CN) 202410851787.6

(51) Int. Cl. H01M 10/6567; H01M 10/613; H01M 10/647; H01M 10/6554; H01M 50/209; H01M 50/264

(52) U.S. Cl. CPC H01M 10/6567; H01M 10/613; H01M 10/647; H01M 10/6554; H01M 50/209; H01M 50/264

(57) ABSTRACT

A battery pack includes: a box; a bracket provided in the box, the bracket being provided with an accommodation cavity therein, immersion liquid being provided in the accommodation cavity, and a first side wall of the accommodation cavity being provided with an opening therethrough along a first direction; and a cell provided in the box, the cell comprising a body and an electrode column protruding from a top end of the body, the electrode column extending through the opening and being immersed in the immersion liquid, the top end of the body being connected to the first side wall and sealing the opening, and a side surface of the body being in contact with the bracket to transfer heat to the immersion liquid through the bracket.

### CROSS-REFERENCE TO RELATED APPLICATION

This application claims priority benefit of Chinese patent application No. 2024108517876 filed on Jun. 27, 2024, entitled “BATTERY PACK”, the entire content of which is incorporated herein for all purposes.

### TECHNICAL FIELD

The present disclosure relates to the field of battery technologies, and in particular to a battery pack.

### BACKGROUND

Battery pack generally includes a plurality of cells to store electrical energy. During charging or discharging of the battery pack, higher heat may be generated at electrode columns of the cells, which requires timely heat dissipation. Otherwise, stability of the cell may be affected.

### SUMMARY

Accordingly, it is necessary to provide a battery pack with respect to the problem of heat dissipation of the cell.

A battery pack includes: a bracket provided with an accommodation cavity therein, immersion liquid being provided in the accommodation cavity, and a first side wall of the accommodation cavity being provided with an opening therethrough along a first direction; and a cell comprising a body and an electrode column protruding from a top end of the body, the electrode column extending through the opening and being immersed in the immersion liquid, the top end of the body being connected to the first side wall and sealing the opening, and a side surface of the body being in contact with the bracket to transfer heat to the immersion liquid through the bracket.

In some embodiments, the battery pack further includes a sealant surrounding the opening, the first side wall is connected to the top end of the body through the sealant.

In some embodiments, the sealant is a light-curing glue; and the bracket is a transparent bracket.

In some embodiments, the accommodation cavity has a second side wall arranged in a circumferential direction, the second side wall and the first side wall cooperatively enclose a mounting groove, the top end of the body is inserted into the mounting groove, and the side surface of the body is in contact with the second side wall.

In some embodiments, the battery pack further includes a top cover provided on the top end of the body, and a height of the top cover is ⅕ to ½ of a height of the body.

In some embodiments, and in the first direction, a depth of the mounting groove is ⅕ to ½ of the height of the body, and the top cover is entirely located in the mounting groove.

In some embodiments, in the first direction, a third side wall of the accommodation cavity is located on a side of the first side wall away from the body, the third side wall being a top of the bracket; and a distance between an upper surface of the third side wall of the accommodation cavity and the electrode column ranges from 0 mm to 20 mm.

In some embodiments, in the first direction, a third side wall of the accommodation cavity is located on a side of the first side wall facing away from the body; and the battery pack further includes a heat dissipation device provided on the third side wall.

In some embodiments, two ends of the bracket in a second direction are respectively provided with a step surface, the battery pack further includes an end plate, one end of the end plate in the first direction being connected to the step surface, the end plate abutting against the cell in the second direction, and the second direction being perpendicular to the first direction; the end plate is connected to the step surface through a fastener, and a sealing gasket is provided where the fastener extends through the bracket.

In some embodiments, the battery pack further includes a liquid cooling plate, the liquid cooling plate being connected to the other end of the end plate in the first direction, and the liquid cooling plate being in contact with the cell.

In some embodiments, a plurality of cells are provided, the plurality of cells are arranged at intervals along a second direction, the electrode column of each of the plurality of cells extends through the opening and is immersed in the immersion liquid, and the second direction is perpendicular to the first direction.

In some embodiments, a top end of the body is hooked to the first side wall, and a sealing member is provided therebetween.

In some embodiments, a cross-sectional area of a top end of the body is greater than a cross-sectional area of the opening.

In some embodiments, a sealing ring is provided between the electrode column and the opening, an inner ring of the sealing ring is sleeved on the electrode column, and an outer ring of the sealing ring fits an inner wall of the opening.

In some embodiments, the second side wall comprises a plurality of sub-side walls, adjacent sub-side walls are connected and perpendicular to each other.

In some embodiments, the second side wall comprises a pair of sub-side walls arranged at intervals, the second side wall has two openings in the circumferential direction, and the mounting groove has two gaps in the circumferential direction.

In some embodiments, the battery pack further includes an elastic prepositioning structure provided on the second side wall in the mounting groove, and the cell is positioned under abutment of the elastic prepositioning structure.

In some embodiments, an outer surface of the bracket is provided with a sealing sleeve, a shape of the sealing sleeve matches an outer contour of the bracket and the sleeve closely fits the bracket, or the sealing sleeve is elastic and fits tightly the bracket.

In some embodiments, the battery pack further includes a box, the bracket and the cell are provided in the box, and an outer surface of the bracket is provided with a hanging member configured to fix the bracket on an inner side wall of the box.

In some embodiments, a filler is filled between the end plate and the cell, the end plate presses the filler to fix the cell.

By providing the immersion liquid in the accommodation cavity of the bracket and placing the electrode column of the cell in the accommodation cavity, the immersion liquid can absorb heat from the electrode column of the cell and quickly transfer the heat to the outside of the bracket, thereby improving a heat dissipation effect of the cell. In addition, the cell is connected to the first side wall of the accommodation cavity, so that the accommodation cavity is isolated from an external space, and the structure is simple while immersive heat dissipation of the electrode column is achieved.

### BRIEF DESCRIPTION OF THE DRAWINGS

FIG. 1 is a schematic view showing assembly of a cell and a bracket in a battery pack according to an embodiment of the present disclosure.

FIG. 2 is a schematic view of the battery pack according to an embodiment of the present disclosure.

### REFERENCE SIGNS

100: battery pack; 1: cell; 11: body; 12: electrode column; 2: bracket; 21: accommodation cavity; 211: first side wall; 212: opening; 213: second side wall; 2131: elastic prepositioning structure; 214: third side wall; 22: mounting groove; 23: step surface; 3: immersion liquid; 4: sealant; 5: heat dissipation device; 6: end plate; 61: filler; 7: fastener; 8: sealing gasket; 9: liquid cooling plate; 10: box.

### DETAILED DESCRIPTION

In order to make the above objectives, features and advantages of the present disclosure more obvious and understandable, specific implementations of the present disclosure are described in detail below with reference to the accompanying drawings. In the following description, many specific details are set forth in order to fully understand the present disclosure. However, the present disclosure can be implemented in many other ways different from those described herein, and those skilled in the art can make similar improvements without departing from the connotation of the present disclosure. Therefore, the present disclosure is not limited by specific embodiments disclosed below.

In the description of the present disclosure, it is to be understood that the orientation or position relationships indicated by the terms “central”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial”, “radial”, “circumferential”, and the like are based on the orientation or position relationships shown in the accompanying drawings and are intended to facilitate the description of the present disclosure and simplify the description only, rather than indicating or implying that the apparatus or element referred to must have a particular orientation or be constructed and operated in a particular orientation, and therefore are not to be interpreted as limiting the present disclosure.

In addition, the terms “first” and “second” are used for descriptive purposes only, which cannot be construed as indicating or implying a relative importance, or implicitly specifying the number of the indicated technical features. Therefore, the features defined with “first” and “second” may explicitly or implicitly include at least one feature. In the description of the present disclosure, the term “a plurality of” means at least two, such as two or three, unless otherwise defined explicitly and specifically.

In the present disclosure, unless otherwise specified and defined explicitly, the terms “mount”, “connect”, “join”, and “fix” should be understood in a broad sense, which may be, for example, a fixed connection, a detachable connection, or an integral connection; a mechanical connection or an electrical connection; or a direct connection, an indirect connection via an intermediate medium, an internal connection between two elements, or interaction between two elements. Those of ordinary skill in the art can understand specific meanings of these terms in the present disclosure according to specific situations.

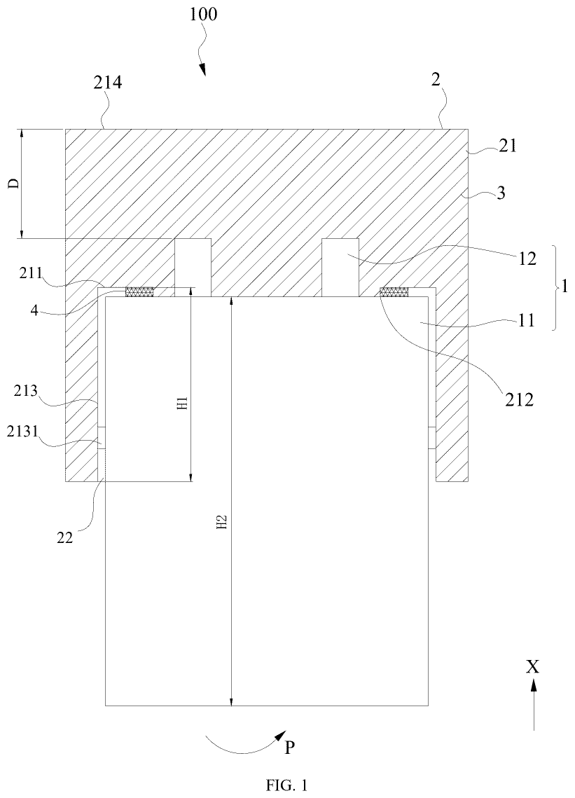

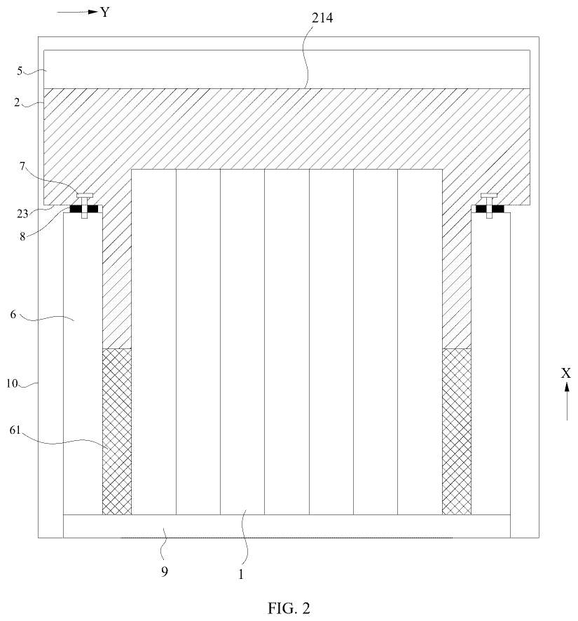

Referring to FIG. 1 to FIG. 2, FIG. 1 is a schematic view showing assembly of a cell 1 and a bracket 2 in a battery pack 100 according to an embodiment of the present disclosure; and FIG. 2 is a schematic view of the battery pack 100 according to an embodiment of the present disclosure. Only one cell 1 is illustrated in FIG. 1. As shown in FIG. 2, a plurality of cells 1 may be provided. The plurality of cells 1 may be arranged in series, in parallel, or in series and in parallel in a box 10 of the battery pack 100. Alternatively, the plurality of battery cells 1 may be combined into a plurality of cell modules.

The battery pack 100 includes a cell 1 and a bracket 2 that are provided in the box 10. An accommodation cavity 21 is provided inside the bracket 2, and immersion liquid 3 is provided in the accommodation cavity 21. A first side wall 211 of the accommodation cavity 21 is provided with an opening 212 therethrough along a first direction X. A specific shape of the accommodation cavity 21 is not limited, as long as it can be assembled with the cell 1.

The cell 1 includes a body 11 and an electrode column 12 protruding from a top end of the body 11. The electrode column 12 extends through the opening 212 and is immersed in the immersion liquid 3. The top end of the body 11 is connected to the first side wall 211 and seals the opening 212. A side surface of the body 11 is in contact with the bracket 2 to transfer heat to the immersion liquid 3 through the bracket 2. As shown in FIG. 1, the first direction X is an up-down direction and is also a height direction of the cell 1.

The electrode column 12 of the cell 1 is configured to be electrically connected to another cell 1 or an external electrical device. The cell 1 is filled with an electrolyte solution. The electrolyte solution includes an electrolyte, which is a carrier for ion transmission in batteries and generally includes a lithium salt and an organic solvent. During charging and discharging of a lithium battery, lithium ions move back and forth between positive and negative electrodes, and the electrolyte solution is a medium through which the lithium ions migrate back and forth, causing a potential difference between the positive and negative electrodes of the battery, thereby generating a current and enabling the battery to operate normally.

In one embodiment, the cell 1 is a secondary battery, such as a pouch-type secondary battery, a rectangular secondary battery, or a cylindrical secondary battery. In the following description, the cell 1 will be described as a rectangular secondary battery.

The opening 212 extends through a first side wall 211, so that the electrode column 12 can be inserted into the accommodation cavity 21. In other words, a side wall of the accommodation cavity 21 is provided with the opening 212, and the opening 212 communicates an inner space of the accommodation cavity 21 with an external space. The side wall provided with the opening 212 is defined as the first side wall 211.

As shown in FIG. 1, when the cell 1 is connected to the bracket 2, the electrode column 12 extends through the opening 212 in the first direction X and is inserted into the accommodation cavity 21. The body 11 of the cell 1 is located outside the accommodation cavity 21.

The top end of the body 11 is connected to a lower end surface of the first side wall 211 and seals the opening 212 at the same time, so that the accommodation cavity 21 is isolated from the external space. For example, the top end of the body 11 is hooked to the first side wall 211 and a sealing member is provided therebetween. A cross-sectional area of the top end of the body 11 is greater than that of the opening 212, as such, after the top end of the body 11 abuts against the first side wall 211, the opening 212 can be closed.

In addition, the side surface of the body 11 is also in contact with the bracket 2, so as to transfer, through the bracket 2, heat generated by the cell 1 during operation to the immersion liquid 3, such that the heat can then be quickly transferred to a heat dissipation device 5 through the immersion liquid 3.

The immersion liquid 3 is a heat-conducting medium configured to cool the cell 1.

Optionally, the immersion liquid 3 is an oily liquid with good insulation properties, such as silicone oil, or a phase change material such as paraffin, which can achieve a temperature control effect on the cell 1.

By providing the immersion liquid 3 in the accommodation cavity 21 of the bracket 2 and placing the electrode column 12 of the cell 1 in the accommodation cavity 21, the immersion liquid 3 can absorb heat from the electrode column 12 of the cell 1 and quickly transfer the heat to the outside of the bracket 2, thereby improving a heat dissipation effect of the cell 1. Moreover, referring to FIG. 2, the bracket 2 is provided with the heat dissipation device 5, and the immersion liquid 3 combines the heat absorbed from the electrode column 12 and heat absorbed from other positions of the body 11 of the cell 1 and then transfers the heat to the heat dissipation device 5. The heat dissipation device 5 can quickly absorb the above heat, thereby ensuring a good operating condition of the cell 1.

In addition, in one embodiment, the cell 1 is connected to the first side wall 211 of the accommodation cavity 21, so that the accommodation cavity 21 is isolated from an external space, and the structure is simple while immersive heat dissipation of the electrode column 12 is achieved. More specifically, on the one hand, the bracket 2 has a simple structure, which only requires an accommodation cavity 21 with an opening 212. On the other hand, assembly of the cell 1 and the bracket 2 only involves two elements, with few structural parts. During the assembly, the cell 1 and the accommodation cavity 21 are in insertion fit, and the assembly process is simple.

In some embodiments, the first side wall 211 is connected to the top end of the body 11 through a sealant 4, and the sealant 4 surrounds the opening 212. The cell 1 is adhered and fixed to the first side wall 211 through the sealant 4. At the same time, the sealant 4 is arranged around the opening 212 to isolate the accommodation cavity 21 from the external space. The type of the seal ant 4 is not limited.

Referring to FIG. 1, when the cell 1 and the bracket 2 are assembled, the opening 212 may face upward, the immersion liquid 3 may be injected into the accommodation cavity 21 through the opening 212, the sealant 4 is applied to the first side wall 211 around the opening 212, and then the electrode column 12 extends into the accommodation cavity 21 through the opening 212, so that the top end of the cell 1 is adhered and fixed to the first side wall 211 and seals the opening 212.

Further, a sealing ring (not shown) is also provided between the electrode column 12 and the opening 212. An inner ring of the sealing ring is sleeved on the electrode column 12, and an outer ring of the sealing ring fits an inner wall of the opening 212. Through the arrangement of the sealing ring, failure of sealing caused by aging of the sealant 4 after long-term use of the battery pack can be prevented, thereby ensuring a better sealing effect.

In some embodiments, the sealant 4 is light-curing glue. The sealant 4 may be cured by light irradiation. For example, the sealant 4 is UV glue. By irradiating ultraviolet rays to the UV glue, the UV glue can be cured.

Further, the bracket 2 is a transparent bracket 2. The bracket 2 is transparent, so that when the sealant 4 is required to be cured by light irradiation, a light source can be flexibly positioned. In some embodiments, the bracket 2 is made of a material with good heat conductivity.

For example, the bracket is made of aluminum. The bracket 2 can easily absorb heat generated by the body 11 of the cell 1 and transfers the heat to the immersion liquid 3, and the bracket 2 can also dissipate the heat to the outside, which has a better heat dissipation effect on the cell 1.

In some embodiments, referring to FIG. 1 and FIG. 2, the accommodation cavity 21 has a second side wall 213 arranged in a circumferential direction P. The second side wall 213 and the first side wall 211 cooperatively enclose a mounting groove 22, and the top end of the body 11 is inserted into the mounting groove 22. The body 11 is in contact with the second side wall 213. The circumferential direction P used herein is a direction surrounding a side surface of the cell 1. After the cell 1 is inserted into the mounting groove 22, the second side wall 213 extends along the side surface of the cell 1 along the circumferential direction P.

In the embodiment shown in FIG. 1, the mounting groove 22 into which the cell 1 may be inserted is formed at a lower portion of the bracket 2. A top wall of the mounting groove 22 is the first side wall 211 of the accommodation cavity 21. A side wall of the mounting groove 22 is the second side wall 213. The bottom of the mounting groove 22 has an opening, through which the cell 1 is inserted.

The second side wall 213 may include a plurality of sub-side walls connected end to end. In this case, there is no gap in the second side wall 213 in the circumferential direction P, and there is no gap in the mounting groove 22 in the circumferential direction P. For example, the second side wall 213 includes four sub-side walls, and adjacent sub-side walls are connected and perpendicular to each other. The second side wall 213 may alternatively have a ring-like structure. The second side wall 213 may alternatively include a pair of sub-side walls arranged at intervals. In this case, the second side wall 213 has two openings in the circumferential direction P, and the mounting groove 22 has two gaps in the circumferential direction P, which can reduce a weight of the bracket 2.

The contact between the body 11 and the second side wall 213 means that at least part of the second side wall 213 is in contact with part of a surface of the body 11. More specifically, the second side wall 213 is in contact with the side surface of the body 11. For example, a shape of the second side wall 213 matches a shape of the side surface of the body 11, and the second side wall 213 is entirely attached to the side surface of the body 11.

In the above arrangement, the structure of the accommodation cavity 21 essentially includes a first part located above the mounting groove 22 and a second part surrounding the mounting groove 22. After the cell 1 is inserted into the mounting groove 22, the immersion liquid 3 is located above the cell 1 and on a side of the cell 1. Therefore, in addition to that the heat at the electrode column 12 of the cell 1 can be quickly transferred to the outside of the bracket 2, the heat generated by the cell 1 can also be quickly transferred outwards through the contact between the cell 1 and the second side wall 213.

When the second side wall 213 surrounds the cell 1 along the circumferential direction P, the side surface of the body 11 of the cell 1 can be in contact with the second side wall 213 everywhere in the circumferential direction P.

In some embodiments, an elastic prepositioning structure 2131 is provided on the second side wall 213 in the mounting groove 22. The cell 1 is positioned under abutment of the elastic prepositioning structure 2131. In this way, before the sealant 4 is cured, the cell 1 is held at a suitable position, so that the cured sealant 4 can seal the opening 212. In addition, after long-term use of the battery pack 100, if the sealant 4 ages, the elastic prepositioning structure 2131 can still hold the cell 1 in position, so that the cell 1 and the bracket 2 can still be sealed by the sealing ring. Specifically, since the position of the cell 1 remains unchanged and the sealing ring is not easy to shake or dislocate, the sealing ring is not easily damaged, and a relative position thereof with the cell 1 and the bracket 2 is relatively stable, so as to have a better sealing effect. For example, the elastic prepositioning structure 2131 is a rubber pad adhered and fixed to the second side wall 213.

Further, the top end of the body 11 is provided with a top cover (not shown), and a height of the top cover is ⅕ to ½ of a height of the body; and in the first direction, a depth H1 of the mounting groove 22 is ⅕ to ½ of the height H2 of the body 11.

For the cell 1, the top end of the body 11 of the cell 1 is provided with the top cover. Regardless of the structure of the top cover, the height thereof does not exceed ⅕ to ½ of the height H2 of the body 11 at most. Accordingly, in one embodiment, the depth H1 of the mounting groove 22 is ⅕ to ½ of the height H2 of the body 11, and the top cover is entirely located in the mounting groove. In this manner, since the top cover of the cell 1 is entirely inserted into the mounting groove 22, the top cover is protected. For example, the depth H1 of the mounting groove 22 can be ⅕, 1.5/5, ⅖, or ½ of the height H2 of the body 11.

In some embodiments, as shown in FIG. 1, in the first direction X, a third side wall 214 of the accommodation cavity 21 is located on a side of the first side wall 211 away from the body 11. The third side wall 214 is a top of the bracket 2. A distance D between an upper surface of the third side wall 214 of the accommodation cavity 21 and the electrode column 12 ranges from 0 mm to 20 mm. For example, D is 0.5 mm, 2 mm, 5 mm, 8 mm, 11 mm, 13 mm, 17 mm, or 20 mm.

In this embodiment, the top of the bracket 2 is the third side wall 214 of the accommodation cavity 21. In other words, the third side wall 214 is configured to enclose the accommodation cavity 21, and an internal space of the accommodation cavity 21 is isolated from the outside by the third side wall 214. Specifically, as shown in FIG. 1, an external space above the third side wall 214 and an internal space of the accommodation cavity 21 below the third side wall 214 are isolated by the third side wall 214. In this way, the heat from the electrode column 12 of the cell 1 is transferred to the immersion liquid 3 and directly transferred to the third side wall 214 through the immersion liquid 3. The third side wall 214 may dissipate the heat to the external space. Alternatively, as shown in FIG. 2, the third side wall 214 transfers the heat absorbed by the immersion liquid 3 during operation of the cell 1 to the heat dissipation device 5 on the third side wall 214.

In this embodiment, the distance D between the upper surface of the third side wall 214 of the accommodation cavity 21 and the electrode column 12 ranges from 0 mm to 20 mm. The upper surface of the third side wall 214 is an upper end surface of the top of the bracket 2. The distance D here does not include 0.

It is found through study that when the distance between the upper end surface of the top of the bracket 2 and the electrode column 12 is 0, the immersion liquid 3 and the bracket 2 have the best heat conduction effect on the electrode column 12. However, in order to reduce a possibility of leakage, an insulating material is further required to be provided on the electrode column 12, resulting in a complicated process and increased process costs.

In order to solve contradiction between the heat conduction effect and process complexity, in this embodiment, the distance D between the upper surface of the third side wall 214 of the accommodation cavity 21 and the electrode column 12 is configured to range from 0 mm to 20 mm. The upper surface of the third side wall 214 is spaced apart from the electrode column 12 to ensure insulation performance and reduce the possibility of leakage. At the same time, a maximum value of the distance D therebetween does not exceed 20 mm, thus ensuring that the heat conduction effect of the immersion liquid 3 and the bracket 2 on the electrode column 12 may not be reduced. After testing and verification, the distance D in the above range can prevent leakage, and heat dissipation efficiency can also meet a requirement. This is reflected in stable operation of the cell 1, and a temperature curve is stable and within a controllable range.

In some embodiments, referring to FIG. 1 and FIG. 2, in the first direction, a third side wall 214 of the accommodation cavity 21 is located on a side of the first side wall 211 away from the body 11. The battery pack 100 further includes a heat dissipation device 5, and the heat dissipation device 5 is arranged on the third side wall 214.

As described above, the third side wall 214 is located on the top of the bracket 2. After the cell 1 and the bracket 2 are assembled and placed into the box 10 together, the third side wall 214 is located above the cell 1. In this way, the heat dissipation device 5 can be mounted on the third side wall 214. Since an operating space above the top is larger, it is more convenient to mount the heat dissipation device 5. In addition, in this embodiment, the heat dissipation device 5 of the battery pack 100 is arranged on the third side wall 214, so that the heat dissipated through the immersion liquid 3 can be absorbed by the heat dissipation device 5, thereby quickly reducing a temperature of the cell 1.

A specific type of the heat dissipation device 5 is not limited. For example, the heat dissipation device 5 may be a plate radiator, a tube radiator, or a fin radiator. It should be to understand that the bottom of the heat dissipation device 5 is completely in contact with the third side wall 214. A manner in which the heat dissipation device 5 is fixed to the third side wall 214 is not limited, which may be connected by, for example, heat-conducting glue or a screw.

In some embodiments, the third side wall 214 of the accommodation cavity 21 is further provided with a liquid injection port (not shown), and a removable protective cover is provided at the liquid injection port. The immersion liquid 3 can be added through the liquid injection port. In this way, the immersion liquid 3 in the accommodation cavity 21 can be replenished or replaced as required.

In some embodiments, an outer surface of the bracket 2 is provided with a sealing layer (not shown). The sealing layer has heat conductivity and has an effect of strengthening the sealing and preventing leakage of the immersion liquid 3. For example, the sealing layer is a sealing sleeve that sleeves the bracket 2. A shape of the sealing sleeve matches an outer contour of the bracket 2 and the sleeve closely fits the bracket 2. Alternatively, the sealing sleeve is elastic and can fit tightly the bracket 2. For example, the sealing layer is a heat-conducting coating with which the outer surface of the bracket 2 is coated.

In some embodiments, the outer surface of the bracket 2 is provided with a hanging member. The hanging member is configured to fix the bracket 2 at a suitable position on an inner wall of the box 10, so that the bracket 2 can be quickly mounted. It should be understood that a plurality of such hanging members may be provided along the circumferential direction P. The hanging member is, for example, a hook, which can fit a recess, a boss, or the like on an inner side wall of the box 10. The hanging member is, for example, a hanging rod, which can fit a hook on the inner side wall of the box 10.

In some embodiments, referring to FIG. 2, two ends of the bracket 2 in a second direction Y are respectively provided with a step surface 23. The battery pack further includes an end plate 6, one end of the end plate 6 in the first direction X is connected to the step surface 23, and the end plate 6 abuts against the cell 1 in the second direction Y. The second direction Y is perpendicular to the first direction X. The second direction Y is a left-right direction in FIG. 2, and the second direction Y is perpendicular to the first direction X.

Two end plates 6 are respectively provided on two sides of the cell 1. The end plate 6 can contact the step surface 23, so that the end plate 6 can support the bracket 2 and the immersion liquid 3. The end plate 6 also abuts against the cell 1 and has an effect of fixing the cell 1. Optionally, the end plate 6 is directly in contact with the lower part of the cell 1, or a filler 61 is filled between the end plate 6 and the cell 1. The end plate 6 presses the filler 61 to fix the cell 1. The filler 61 can be foam, polypropylene film, diatomite, aramid fiber, ceramic fiber, etc.

A manner in which the end plate 6 is fixed to the step surface 23 is not limited, as long as the sealing of the accommodation cavity 21 can prevent leakage of the immersion liquid 3. For example, the end plate 6 is connected to the step surface 23 through a fastener 7, and a sealing gasket 8 is provided where the fastener 7 extends through the bracket 2. The fastener 7 is, for example, a screw. The fastener 7 is configured to connect the bracket 2 and the end plate 6 to reduce a possibility of displacement of the bracket 2. The sealing gasket 8 isolates a contact interface between the fastener 7 and the bracket 2 from the outside to prevent leakage of the immersion liquid 3.

In some embodiments, referring to FIG. 2, the battery pack 100 further includes a liquid cooling plate 9, the liquid cooling plate 9 is connected to the other end of the end plate 6 in the first direction X, and the liquid cooling plate 9 is in contact with the cell 1. The liquid cooling plate 9 is configured to absorb heat generated at a lower end of the cell 1. The liquid cooling plate 9 is a plate heat dissipation element that realizes heat exchange through liquid.

In some embodiments, referring to FIG. 2, the battery pack 100 includes a plurality of cells 1, and the plurality of cells 1 are arranged at intervals along the second direction Y. The electrode column 12 of each cell 1 extends through the opening 212 and is immersed in the immersion liquid 3, and the second direction Y is perpendicular to the first direction X.

Optionally, the plurality of cells 1 share one bracket 2. For example, a mounting groove 22 is formed at a lower part of the bracket 2. In the second direction Y, a size of the mounting groove 22 of the bracket 2 is enough to accommodate the plurality of cells 1. In this case, a number of the opening 212 in the first side wall 211 of the accommodation cavity 21 is equal to a number of the cell 1. In the second direction Y, adjacent cells 1 may be close to each other, or fillers may be provided to create intervals. Optionally, each cell 1 is provided with one bracket 2.

In some embodiments, referring to FIG. 2, the battery pack 100 further includes a box 10, and the bracket 2 and the cell 1 are arranged in the box 10. One or more cells 1 are arranged in the box 10 together with the bracket 2.

Optionally, the box 10 includes a base and an upper cover, and the upper cover and the base are combined to enclose a storage cavity. The cell 1 and the bracket 2 thereon are arranged in the storage cavity.

In the present disclosure, unless otherwise explicitly specified and defined, the expression a first feature being “on” or “under” a second feature may be the case that the first feature is in direct contact with the second feature, or the first feature is in indirect contact with the second feature via an intermediate medium. Furthermore, the expression the first feature being “over”, “above” and “on top of” the second feature may be the case that the first feature is directly above or obliquely above the second feature, or only means that the level of the first feature is higher than that of the second feature. The expression the first feature being “below”, “underneath” or “under” the second feature may be the case that the first feature is directly underneath or obliquely underneath the second feature, or only means that the level of the first feature is lower than that of the second feature.

It is to be noted that when one element is referred to as being “fixed to” or “arranged on” another element, it may be directly disposed on the other element or an intermediate element may exist. When one element is considered to be “connected to” another element, it may be directly connected to the other element or an intermediate element may co-exist. The terms “vertical”, “horizontal”, “upper”, “lower”, “left”, “right”, and similar expressions used in the present disclosure are for illustrative purposes only and do not represent an only implementation.

The technical features of the above embodiments can be combined arbitrarily. In order to make the description concise, not all possible combinations of the technical features are described in the embodiments. However, as long as there is no contradiction in the combination of these technical features, the combinations should be considered as in the scope of the specification.

The above embodiments are only several implementations of the present disclosure, and the descriptions are relatively specific and detailed, but they should not be construed as limiting the scope of the present disclosure. It should be understood by those of ordinary skill in the art that various modifications and improvements can be made without departing from the concept of the present disclosure, and all fall within the protection scope of the present disclosure. Therefore, the patent protection of the present disclosure shall be defined by the appended claims.

What is claimed is:

1. A battery pack, comprising:
a bracket provided with an accommodation cavity therein, immersion liquid being provided in the accommodation cavity, and a first side wall of the accommodation cavity being provided with an opening therethrough along a first direction; and
a cell comprising a body and an electrode column protruding from a top end of the body, the electrode column extending through the opening and being immersed in the immersion liquid, the top end of the body being connected to the first side wall and sealing the opening, and a side surface of the body being in contact with the bracket to transfer heat to the immersion liquid through the bracket.

2. The battery pack according to claim 1, further comprising a sealant surrounding the opening, wherein the first side wall is connected to the top end of the body through the sealant.

3. The battery pack according to claim 2, wherein the sealant is a light-curing glue, and the bracket is a transparent bracket.

4. The battery pack according to claim 1, wherein the accommodation cavity has a second side wall arranged in a circumferential direction, the second side wall and the first side wall cooperatively enclose a mounting groove, the top end of the body is inserted into the mounting groove, and the side surface of the body is in contact with the second side wall.

5. The battery pack according to claim 4, further comprising a top cover provided on the top end of the body, wherein a height of the top cover is ⅕ to ½ of a height of the body.

6. The battery pack according to claim 5, wherein in the first direction, a depth of the mounting groove is ⅕ to ½ of the height of the body, and the top cover is entirely located in the mounting groove.

7. The battery pack according to claim 1, wherein in the first direction, a third side wall of the accommodation cavity is located on a side of the first side wall away from the body, the third side wall is a top of the bracket, and a distance between an upper surface of the third side wall of the accommodation cavity and the electrode column ranges from 0 mm to 20 mm.

8. The battery pack according to claim 1, wherein in the first direction, a third side wall of the accommodation cavity is located on a side of the first side wall away from the body, and the battery pack further comprises a heat dissipation device provided on the third side wall.

9. The battery pack according to claim 1, wherein two ends of the bracket in a second direction are respectively provided with a step surface, the battery pack further comprises an end plate, one end of the end plate in the first direction is connected to the step surface, the end plate abuts against the cell in the second direction, the second direction is perpendicular to the first direction; wherein the end plate is connected to the step surface through a fastener, and a sealing gasket is provided where the fastener extends through the bracket.

10. The battery pack according to claim 9, further comprising a liquid cooling plate connected to another end of the end plate in the first direction, and the liquid cooling plate being in contact with the cell.

11. The battery pack according to claim 1, wherein a plurality of cells are provided, the plurality of cells are arranged at intervals along a second direction, the electrode column of each of the plurality of cells extends through the opening and is immersed in the immersion liquid, and the second direction is perpendicular to the first direction.

12. The battery pack according to claim 1, wherein a top end of the body is hooked to the first side wall, and a sealing member is provided therebetween.

13. The battery pack according to claim 1, wherein a cross-sectional area of a top end of the body is greater than a cross-sectional area of the opening.

14. The battery pack according to claim 1, wherein a sealing ring is provided between the electrode column and the opening, an inner ring of the sealing ring is sleeved on the electrode column, and an outer ring of the sealing ring fits an inner wall of the opening.

15. The battery pack according to claim 4, wherein the second side wall comprises a plurality of sub-side walls, adjacent sub-side walls are connected and perpendicular to each other.

16. The battery pack according to claim 4, wherein the second side wall comprises a pair of sub-side walls arranged at intervals, the second side wall has two openings in the circumferential direction, and the mounting groove has two gaps in the circumferential direction.

17. The battery pack according to claim 4, further comprising an elastic prepositioning structure provided on the second side wall in the mounting groove, wherein the cell is positioned under abutment of the elastic prepositioning structure.

18. The battery pack according to claim 1, wherein an outer surface of the bracket is provided with a sealing sleeve, and a shape of the sealing sleeve matches an outer contour of the bracket and the sleeve closely fits the bracket, or the sealing sleeve is elastic and fits tightly the bracket.

19. The battery pack according to claim 1, further comprising a box, wherein the bracket and the cell are provided in the box, and an outer surface of the bracket is provided with a hanging member configured to fix the bracket on an inner side wall of the box.

20. The battery pack according to claim 9, wherein a filler is filled between the end plate and the cell, the end plate presses the filler to fix the cell.
